(19) United States
(12) Patent Application Publication
(10) Pub. No.: US 2017/0036386 A1
(43) Pub. Date: Feb. 9, 2017

(54) CO-EXTRUSION DIE WITH RECTANGULAR FEED CHANNEL

(71) Applicant: Macro Technology Ltd., Mississauga (CA)

(72) Inventors: Miroslav Planeta, Mississauga (CA); Harinder Tamber, Brampton (CA); Hassan Eslami, Mississauga (CA)

(21) Appl. No.: 15/269,860

(22) PCT Filed: Apr. 2, 2015
(86) PCT No.: PCT/CA2015/000238

§ 371 Date: Sep. 19, 2016

Related U.S. Application Data
(60) Provisional application No. 61/974,867, filed on Apr. 3, 2014.

(51) Int. Cl. B29C 47/26; B29C 47/06; B29C 47/28; B29C 47/00

(52) U.S. Cl. CPC B29C 47/263; B29C 47/0026; B29C 47/065; B29C 47/28; B29L 2009/00

(57) ABSTRACT

A body member for an extrusion die for multilayer film has a passage-forming surface and an open feed channel formed in the passage-forming surface. The feed channel continuously decreases in depth from the feed channel inlet, and the feed channel is of substantially constant-width substantially rectangular cross-section along substantially its entire extent. Corners of the feed channel may be slightly rounded. Substantially constant-width feed channels of substantially rectangular cross-section may be used in blown film applications, in which case the feed channel extends in a spiral from the feed channel inlet, and in cast film applications, in which case the feed channel extends substantially linearly from the feed channel inlet. Dies can be assembled by arranging two body members with their respective passage-forming surfaces opposed to one another.

### CROSS-REFERENCE TO RELATED APPLICATION

This application claims priority to U.S. Provisional Application No. 61/974,867 filed on Apr. 3, 2014, the teachings of which are hereby incorporated by reference.

### TECHNICAL FIELD

The present disclosure relates to co-extrusion of plastic materials in the form of multilayer film.

### BACKGROUND

Co-extruded multilayer film has particular advantages since it allows for a single film to combine different materials so that the benefits of one material can offset the drawbacks of another material. For example, a material with good oxygen barrier properties but poor strength could be co-extruded with a material that is stronger but has poor oxygen barrier properties, resulting in a co-extruded film that has both the required strength and the required oxygen barrier properties. In some applications, it can be desirable to have films which have large numbers of layers to achieve desired properties but which have a maximum thickness, requiring the individual layers to be very thin, on the order of micrometers or nanometers. Such films are referred to as “microlayer” and “nanolayer” films, respectively.

It is known in blown film applications to use a spiral feed channel coupled to a feed block to provide multiple layers. Examples include U.S. Pat. No. 6,409,953 and 6.116,885. However, such prior art spiral feed channels have been of curved cross-section such as semicircular, parabolic or otherwise substantially curved, which can make it difficult to achieve a desired layer distribution. In particular, the cross-sectional shape of the feed channels does not distribute the microlayers or nanolayers evenly because the layers at the curved edges of the feed channels are shorter than those in the center, leading to unequal spillover. As a consequence, different circumferential portions of the resulting film may have different numbers of layers, decreasing the quality and performance of the film.

### SUMMARY

A feed channel of substantially rectangular cross-section may be used in multilayer film applications, with particularly advantageous application to microlayer and nanolayer films. Because the feed channel is of substantially rectangular cross-section, the layers will be of substantially equal length, which may result in a more consistent spillover during the extrusion process.

In one aspect, a body member for an extrusion die for multilayer film has a passage-forming surface and has at least one open feed channel formed in the passage-forming surface. Each feed channel continuously decreases in depth from the feed channel inlet, and each feed channel is of substantially constant-width substantially rectangular cross-section along substantially its entire extent.

In preferred embodiments, the rectangular cross-section of the feed channel has corners rounded to a radius of not more than about 1/16 of an inch; more preferably the corners are rounded to a radius of not more than about 1/32 of an inch.

In one embodiment, the body member is a body member for an annular co-extrusion die for blown film, the feed channel extends in a spiral from the feed channel inlet and the feed channel extends, from the feed channel inlet, at least 180 degrees around an origin of the spiral. In a particular embodiment, the feed channel extends, from the feed channel inlet, at least 360 degrees around the origin of the spiral, and the feed channel may extend, from the feed channel inlet, between 360 degrees and 720 degrees around the origin of the spiral.

The body member may be annular.

An annular co-extrusion die for blown plastic film may comprise two body members as described above, with the body members arranged with their respective passage-forming surfaces opposed to one another to form a first portion of an annular passage therebetween. The first portion of the annular passage is substantially perpendicular to the extrusion direction, and a second portion of the annular passage extends generally in the extrusion direction and extends into an annular extrusion orifice in fluid communication therewith. The first and second portions of the annular passage are continuous with one another and in fluid communication with one another. The respective spirals formed by the feed channels may extend in opposite directions, and the respective spirals formed by the feed channels may overlap one another.

The annular co-extrusion die may further comprise an annular membrane arranged in parallel with the passage-forming surfaces to bisect the annular passage.

The annular co-extrusion die may further comprise a feed block adaptor having a longitudinally extending bore of substantially rectangular cross-section, with the respective feed channel inlets cooperating to form a common feed channel inlet of substantially rectangular cross-section corresponding in size and shape to the bore of the feed block adaptor and the bore of the feed block adaptor is in registration with the common feed channel inlet. Thus, the feed channel inlets of each body member may be in registration with one another. In other embodiments, the feed channel inlets of each body member may be offset from one another, and may be offset from one another by about 180 degrees.

A co-extrusion structure may comprise at least one annular co-extrusion die as described above arranged in stacked relation adjacent at least one other annular extrusion die, with each other annular extrusion die having a respective annular extrusion passage extending substantially in the extrusion direction and the second portion of the annular passage of each annular co-extrusion die as described above in registration with and in fluid communication with the annular extrusion passage of each other annular extrusion die.

In another embodiment, the body member is a body member for a co-extrusion die for extruding cast film, and the feed channel extends substantially linearly from the feed channel inlet.

A co-extrusion die for extruding cast film may comprise two body members as described above, with the body members arranged with their respective passage-forming surfaces opposed to one another to form an extrusion passage therebetween.

The feed channels may extend in a common direction from a common inlet, and the feed channels may overlap one another.

### BRIEF DESCRIPTION OF THE DRAWINGS

These and other features will become more apparent from the following description in which reference is made to the appended drawings wherein:

FIG. 1 is a top plan view of an exemplary co-extrusion assembly;

FIG. 2 is a side elevation view of the co-extrusion assembly of FIG. 1;

FIG. 3 is a cross-sectional view of a first annular co-extrusion die, taken along the line 3-3 in FIG. 7:

FIG. 3A is a cross-sectional view of a second annular co-extrusion die;

FIG. 4 is a detailed cross-sectional view of a portion of the annular co-extrusion die of FIG. 3;

FIG. 5 is an exploded view of a portion of the annular co-extrusion die of FIG. 3 showing two body members and a membrane thereof in perspective view;

FIG. 5A is an exploded view of a portion of the annular co-extrusion die of FIG. 3A showing two body members and a membrane thereof in perspective view;

FIG. 6A is a top plan view of the lowermost body member shown in FIG. 5;

FIG. 6B is a side elevation view of the body member of FIG. 6A;

FIG. 6C is a cross-sectional view of a portion of the body member of FIG. 6A, taken along the line 6C-6C in FIG. 6A;

FIG. 6D is a cross-sectional view of a portion of the body member of FIG. 6A, taken along the line 6D-6D in FIG. 6A;

FIG. 6E is a cross-sectional view of a portion of the body member of FIG. 6A, taken along the line 6E-6E in FIG. 6A;

FIG. 6F is a cross-sectional view of a portion of the body member of FIG. 6A, taken along the line 6F-6F in FIG. 6A;

FIG. 7 is a top plan view of the annular co-extrusion die of FIG. 3;

FIG. 7A is a bottom plan view of the uppermost body member shown in FIG. 5;

FIG. 7B is a side elevation view of the body member of FIG. 7A;

FIG. 8 is a detail view of a portion of the lowermost body member shown in FIG. 5;

FIG. 9 is a side elevation view, partly in cross-section, of the co-extrusion assembly of FIG. 1;

FIG. 9A is a cross-sectional view of a portion of a feed block adaptor forming part of the co-extrusion assembly of FIG. 1, taken along the line 9A-9A in FIG. 9;

FIG. 9B is a cross-sectional view of a portion of a common feed channel of the annular co-extrusion die of FIG. 3, taken along the line 9B-9B in FIG. 9;

FIG. 10A shows the same cross-sectional view as shown in FIG. 9A, with a multilayer plastic melt disposed in a bore of the feed block adaptor;

FIG. 10B shows the same cross-sectional view as shown in FIG. 9B, with a multilayer plastic melt disposed in the common feed channel;

FIG. 11 is a side cross-sectional view showing an exemplary co-extrusion structure comprising a plurality of annular co-extrusion dies;

FIG. 12 is a schematic side view of an exemplary cast film extrusion die;

FIG. 13 is a schematic end view of the cast film extrusion die of FIG. 12; and

FIG. 14 is a schematic exploded perspective view of the cast film extrusion die of FIG. 12.

### DETAILED DESCRIPTION

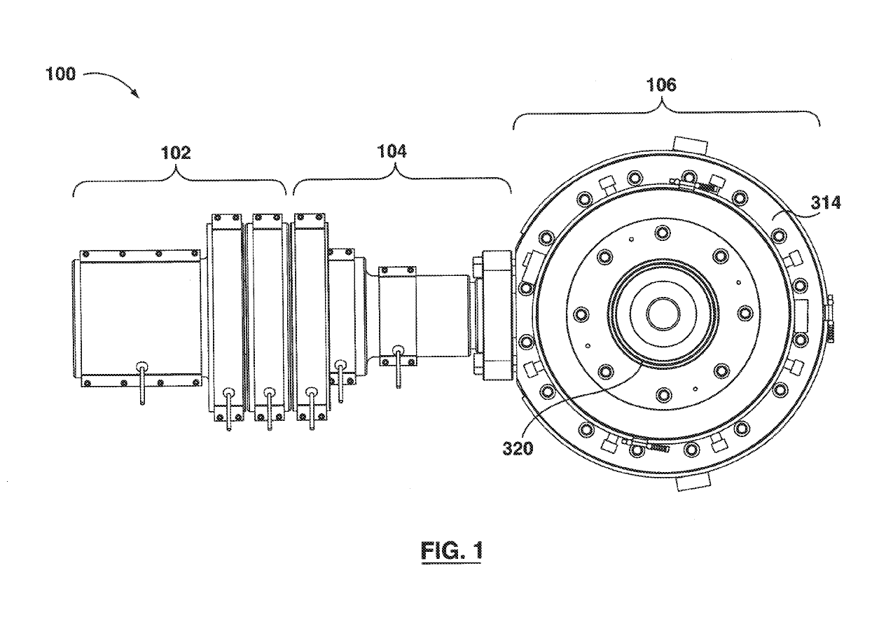

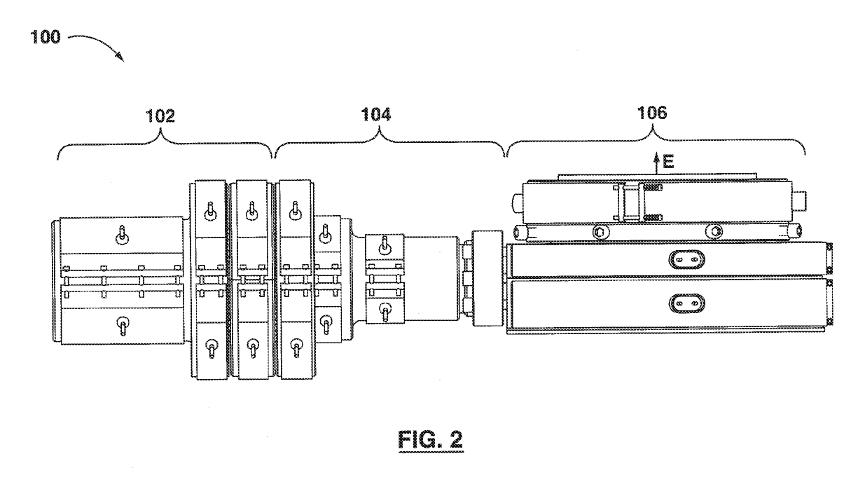

Reference is now made to FIGS. 1 and 2, which show, respectively, top plan and side elevation views of an exemplary co-extrusion assembly 100 comprising a multilayer feed block 102, a feed block adaptor 104 and an annular co-extrusion die 106 for producing multilayer blown film.

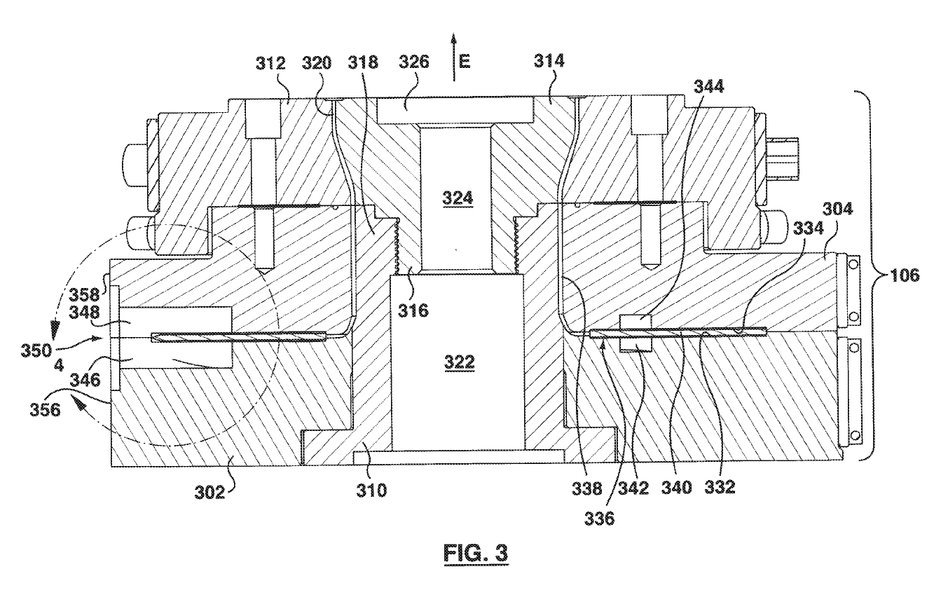

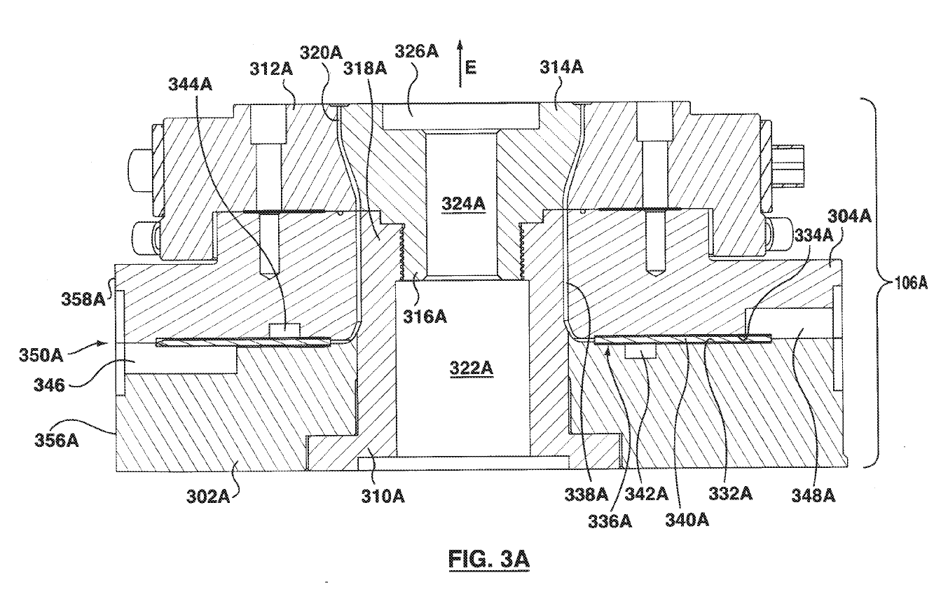

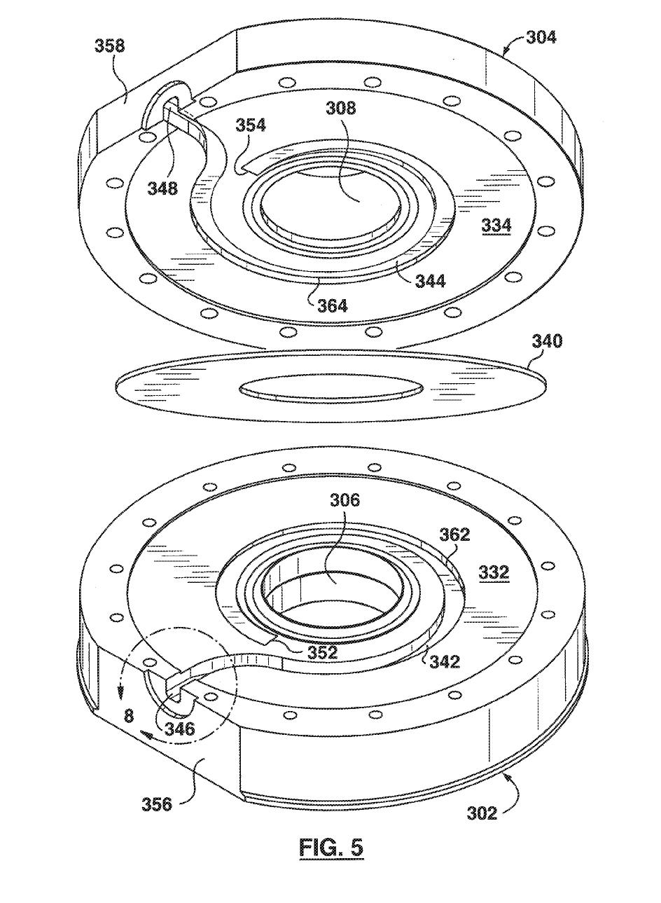

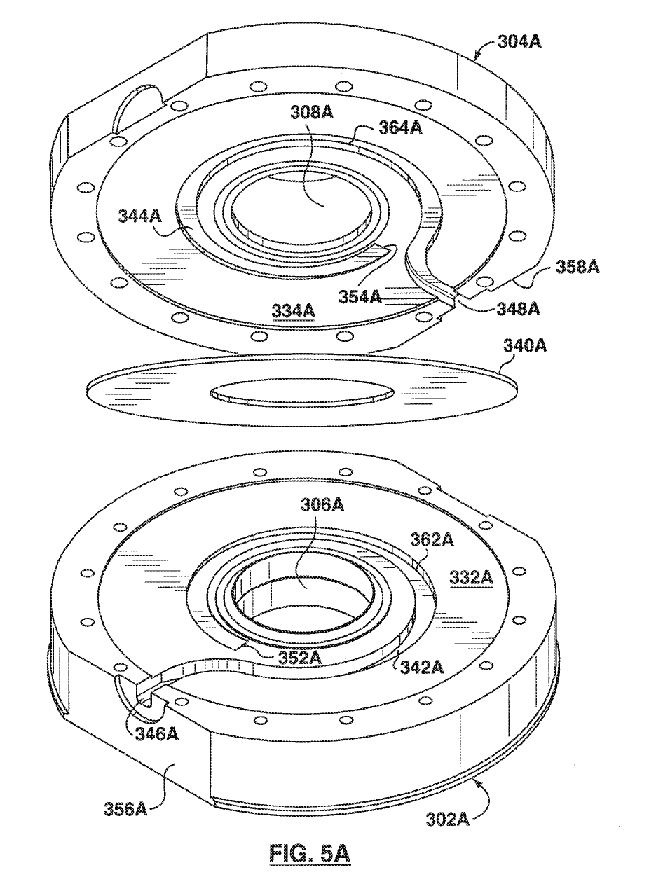

As best seen in the cross-sectional view shown in FIG. 3, the exemplary annular co-extrusion die 106 comprises a first, lowermost body member 302 and a second, uppermost body member 304. The lowermost body member 302 and the uppermost body member 304 are arranged in opposed relation to one another, with the uppermost body member 304 stacked atop the lowermost body member 302. As best seen in FIG. 5, the body members 302, 304 are generally annular and have respective central apertures 306, 308 therethrough. Referring again to FIG. 3, an annular support member 310 is received in the central apertures 306, 308 (FIG. 5). An annular outer lip member 312 is stacked atop the uppermost body member 304, and an annular inner lip member 314 is positioned in the outer lip member 312. The inner diameter of the outer lip member 312 is slightly larger than the outer diameter of the inner lip member 314 so that an annular extrusion orifice 320 is formed by the annular gap between the outer lip member 312 and the inner lip member 314. The inner lip member 314 is supported in the outer lip member 312 by the support member 310, with the lower end 316 of the inner lip member 314 being threadedly received in the upper end 318 of the support member 310. The support member 310 and the inner lip member 314 have respective bores 322, 324 defined therethrough which communicate with one another and cooperate to form a passage for supplying air or another suitable gas to an aperture 326 disposed within the inner lip member 314 and therefore, interiorly of the extrusion orifice 320.

In operation during the blown film process, a tube of plastic film is extruded from the extrusion orifice 320 and air or another suitable gas is fed into the tube from the aperture 326 disposed within the circle formed by the extrusion orifice 320 to expand the tube into a bubble, which can then be handled using conventional techniques. The extrusion direction, that is, the direction in which the tube of plastic film is extruded from the extrusion orifice 320, is shown by an arrow E. Feeding of plastic melt to the extrusion orifice 320 is described in greater detail below.

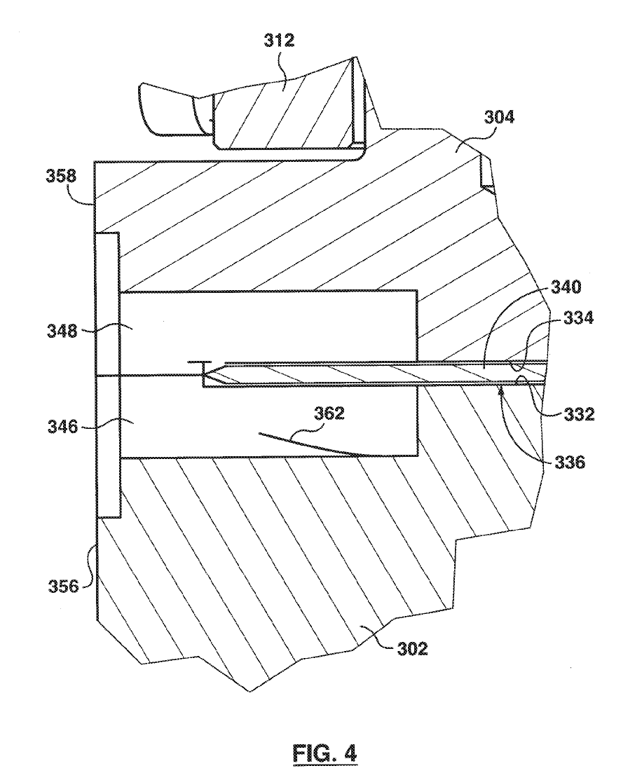

As best seen in FIG. 5, the body members 302, 304 for the annular extrusion die 106 each have a respective passage-forming surface 332, 334. As can be seen in FIGS. 3 and 4, the passage-forming surfaces 332, 334 each extend substantially perpendicularly to the extrusion direction E. The body members 302, 304 are arranged with their respective passage-forming surfaces 332, 334 opposed to and spaced from one another so that the gap between the passage-forming surfaces 332, 334 forms a first portion 336 of an annular passage. Since it is formed by the passage-forming surfaces 332, 334 which extend substantially perpendicularly to the extrusion direction E, the first portion 336 of the annular passage also extends substantially perpendicularly to the extrusion direction E. The first portion 336 of the annular passage is continuous with and extends into a second portion 338 of the annular passage in fluid communication therewith. The second portion 338 of the annular passage is formed by an annular gap between the uppermost body member 344 and the support member 310, and extends generally in the extrusion direction E. In the illustrated embodiment, the second portion 338 of the annular passage extends substantially parallel to the extrusion direction E; in other embodiments the second portion of the annular passage may be non-parallel with the extrusion direction E. The second portion 338 of the annular passage extends into the extrusion orifice 320 in fluid communication therewith.

In the illustrated embodiment, as can be seen in FIGS. 3, 4 and 5, the exemplary annular extrusion die 106 comprises an annular membrane 340 arranged in parallel with the passage-forming surfaces 332, 334 to bisect the first portion 336 of the annular passage. The term “bisect” as used in this context is not intended to imply equal division, and the membrane 340 may be closer to one of the passage-forming surfaces 332, 334 than to the other. The annular membrane may be made of any suitable material. In other embodiments, the annular membrane may be omitted.

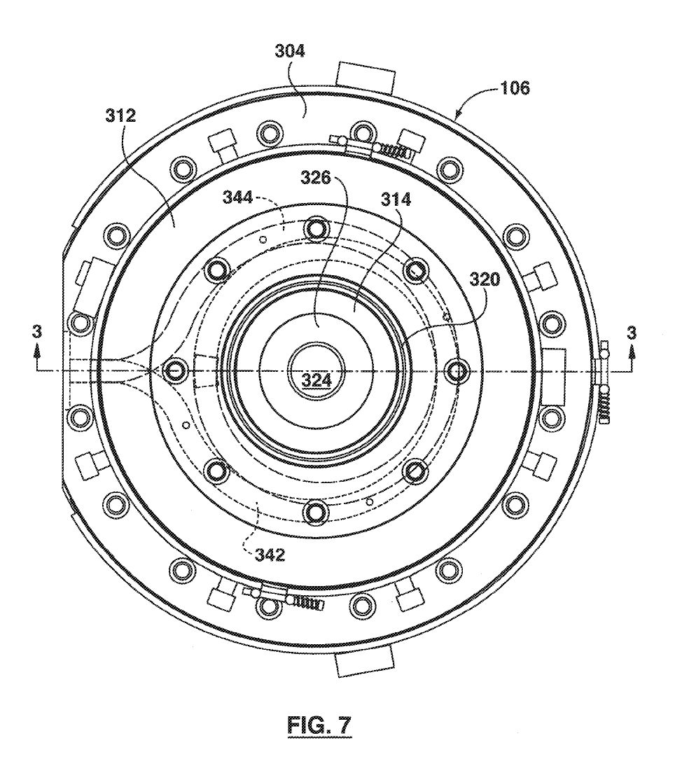

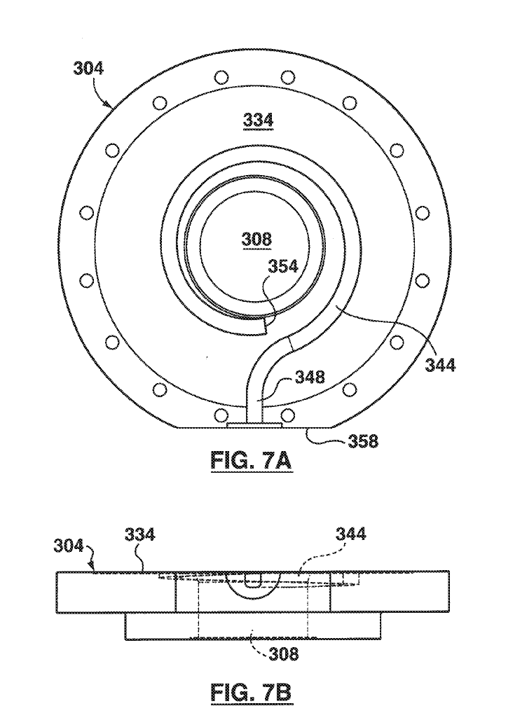

Referring now to FIGS. 5 and 6A to 7B, each of the body members 302, 304 has a respective open feed channel 342, 344 formed in its respective passage-forming surface 332, 334. Each of the feed channels 342, 344 extends in a spiral from a respective feed channel inlet 346, 348 disposed at the outer edge 356, 358 of the respective body member 302, 304. As best seen in FIGS. 5, 6A and 7A, in the illustrated embodiment the feed channels 342, 344 extend, from the respective feed channel inlets 346, 348, about 360 degrees around the origin of the spiral and the respective spirals formed by the feed channels 342, 344 extend in opposite directions and overlap one another. This overlap is best seen in FIG. 7.

In alternate embodiments, so long as the respective spirals formed by the feed channels extend in opposite directions, the spiral formed by the feed channels may extend as little as about 180 degrees around the origin of the spiral. Preferably, the spiral formed by each feed channel extends, from the feed channel inlet, between at least about 360 degrees and about 720 degrees around the origin of the spiral. Where the feed channel extends 720 degrees around the origin of the spiral, it will double the number of layers in the resulting film, as compared to the case where the feed channel extends 360 degrees around the origin of the spiral. In some embodiments, the feed channel may extend more than 720 degrees around the origin of the spiral.

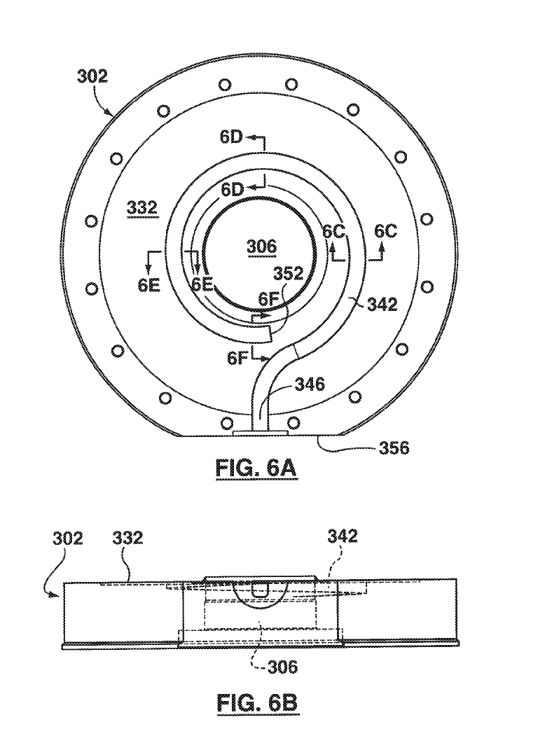

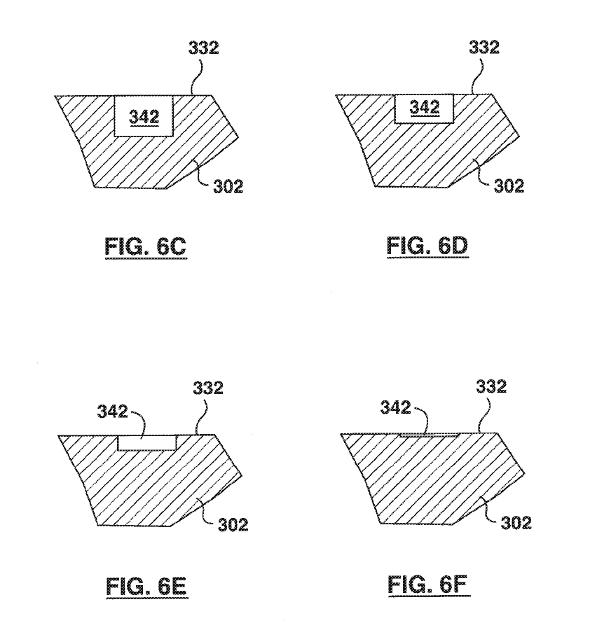

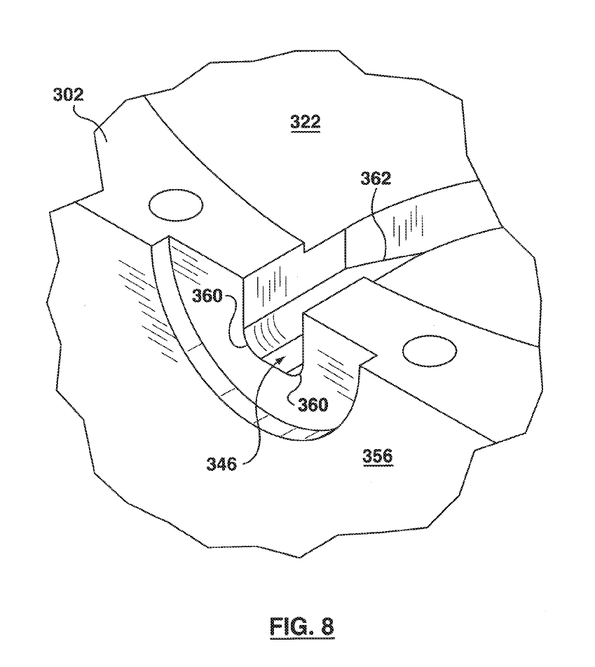

Now referring in particular to FIGS. 6C to 6F, which are cross-sections taken at various positions along the length of the feed channel 342, it can be seen that the feed channel 342 on the first body member 302 smoothly continuously decreases in depth, measured from the respective passage-forming surface 332, from the feed channel inlet 346 to the end 352 of the feed channel 342 (see FIG. 5). In other words, the feed channel 342 continuously becomes shallower from the feed channel inlet 346 to the end 352 of the feed channel 342. It can also be seen in FIGS. 6C to 6F that the feed channel 342 is of substantially constant-width substantially rectangular cross-section along substantially its entire extent. Similarly, although not shown in the same detail, the feed channel 344 on the second body member also smoothly continuously decreases in depth. i.e. continuously becomes shallower, from the feed channel inlet 348 to the end 354 of the feed channel 344, and this feed channel 344 is also of substantially constant-width substantially rectangular cross-section along substantially its entire extent. The cross-section of feed channels 342, 344 may depart slightly from perfectly rectangular, and may have corners 362, 364 (FIG. 5) rounded to a radius of not more than about 1/16 of an inch, and preferably not more than about 1/32 of an inch, to inhibit accumulation of plastic melt, as shown in FIG. 8. Such slightly rounded corners are encompassed within the meaning of the term “substantially rectangular”. The feed channels 342, 344 need not have identical dimensions. As can be seen in FIGS. 6C to 6F, the feed channel 342 is arranged with its sides substantially perpendicular to the flow surface formed by the passage-forming surface 332.

As can be seen in FIG. 8, while the corners 360 at the feed channel inlet 346 on the first body member 302 may be considerably rounded, the corners 362 sharpen considerably as the feed channel inlet 346 transitions to the substantially constant-width substantially rectangular cross-sectional shape of the feed channel 342; the same applies in respect of the feed channel inlet 348 and feed channel 344 on the second body member 304.

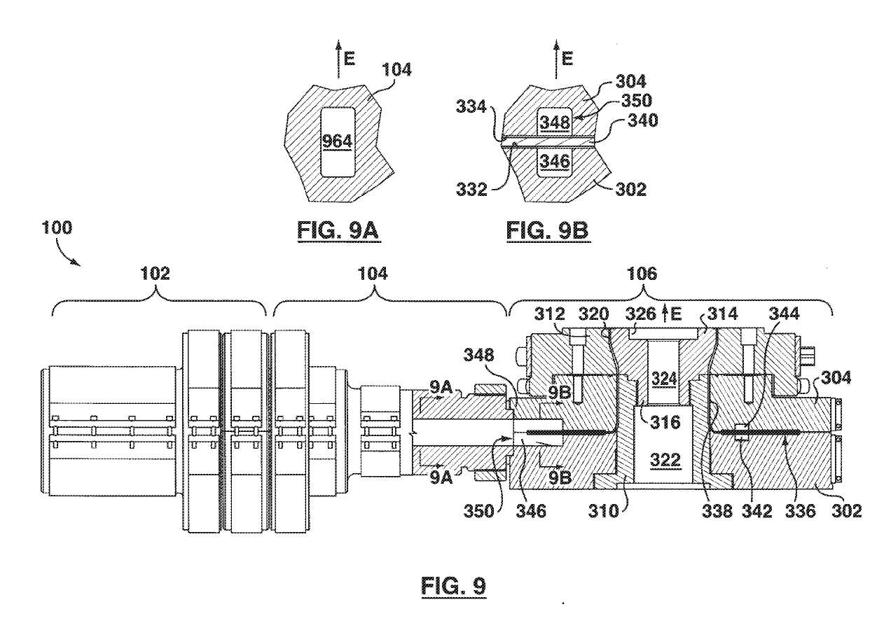

Now referring to FIG. 9, the feed block adaptor 104 has a longitudinally extending bore 964 of substantially constant substantially rectangular cross-section, and the respective feed channel inlets 346, 348 cooperate to form a common feed channel inlet 350 of substantially rectangular cross-section corresponding in size and shape to the bore 964 of the feed block adaptor 104. The bore 964 of the feed block adaptor 104 is in registration with the common feed channel inlet 350 to feed plastic melt into the feed channels 342, 344.

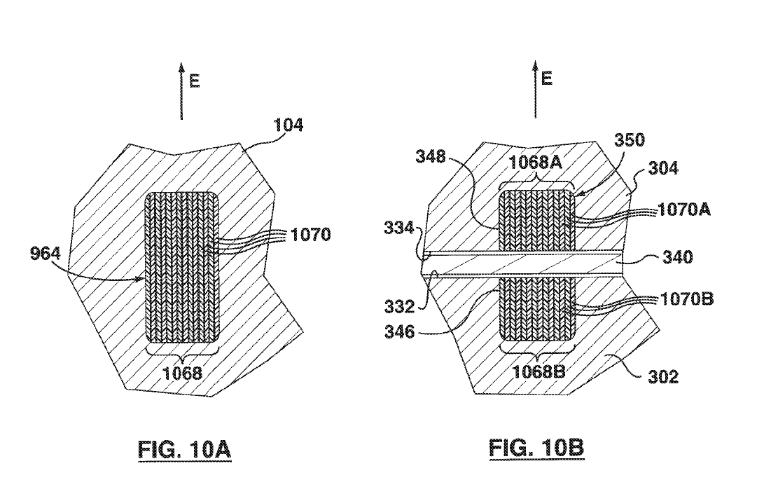

As noted above, the feed block 102 is a multilayer feed block. The feed block 102 is coupled to at least two extruders to receive streams of at least two different materials and is structured so that the different materials are arranged into a multilayered plastic melt 1068 in which the layers 1070 (FIG. 10A) extend substantially parallel to the extrusion direction E when the plastic melt enters the bore 964 of the feed block adaptor 104. The multilayered plastic melt 1068 may comprise any suitable number of materials, any suitable number of layers 1070 and may have any suitable layer arrangement. By way of non-limiting example, two different materials A and B may be arranged in alternating layers ABABAB, and three different materials A, B and C may be arranged ABCABC or ABCBA or ABABC or ACBABABCA, and so on. The layers 1070 may be of equal thickness or unequal thickness. The layers may be, by way of non-limiting example, microlayers, in which the layer thickness is measured in micrometers, or nanolayers, in which the layer thickness is measured in nanometers. The feed block 102 may be a conventional multilayer feed block, and may be, for example, a multilayer feed block offered under the name “NanoLayer” by Cloeren Incorporated, having an office at 401 16^{th} Street, Orange, Tex, 77630 U.S.A.

The substantially constant-width substantially rectangular cross-section of the feed channels 342, 344 makes them particularly well-suited for handling multilayer plastic melt. Because the bore 964 of the feed block adaptor 104 is of substantially constant substantially rectangular cross-section, the layers 1070 will be of substantially equal length, measured in the extrusion direction E. As seen in FIG. 10B, when the plastic melt 1068 passes through the common feed channel inlet 350, also of substantially rectangular cross-section, the plastic melt 1068 is bisected by the membrane 340 into a first flow 1068A which enters the uppermost feed channel 344 and a second flow 1068B which enters the lowermost feed channel 342. The term “bisected” as used in this context is not intended to imply equal division, and the membrane 340 may be closer to one of the passage-forming surfaces 332, 334 than to the other. Because the feed channels 342, 344 are of substantially constant-width substantially rectangular cross-section along substantially their entire extent, the layers 1070B, 1070A in each feed channel 342, 344 will be of substantially equal length, measured in the extrusion direction E. The layers 1070A in the uppermost feed channel 344 may be of a different length than the layers 1070B in the lowermost feed channel 342, depending on the dimensions of the feed channels 342, 344.

As noted above, the feed channels 342, 344 smoothly continuously decrease in depth, measured from the respective passage-forming surfaces 332, 334, from the feed channel inlet 346, 348 to the ends 352, 354 of the feed channels 342, 344. As the first flow 1068A proceeds along the uppermost feed channel 344 and the second flow 1068B proceeds along the lowermost feed channel 342, the decreasing depth of the feed channels 344, 342 causes the first flow 1068A and the second flow 1068B to flow inwardly over the innermost wall of the respective feed channel 344, 342 toward and into the first portion 336 of the annular passage, where the two flows 1068A, 1068B merge into a unified single flow of multilayer plastic melt comprising the first flow 1068A atop the second flow 1068B, with the layers 1070A, 1070B parallel to the first portion 336 of the annular passage. The unified single flow of multilayer plastic melt continues into the second portion 338 of the annular passage and then into and through the extrusion orifice 320 with the layers parallel to the extrusion direction E.

In the first exemplary annular co-extrusion die 106 shown in FIGS. 1 to 3, 4, 5, 7 and 8 to 10, the body members 302, 304 are arranged so that the respective feed channel inlets 346, 348 of each body member 302, 304 are in registration with one another. In alternate embodiments, the feed channel inlets of each body member may be offset from one another. FIGS. 3A and 5A show a second exemplary annular co-extrusion die 106A which is similar to the first exemplary annular co-extrusion die 106 shown in FIGS. 1 to 3, 4, 5, 7 and 8 to 10, with like references referring to like features except with the suffix “A”. The second exemplary annular co-extrusion die 106A differs from the first exemplary annular co-extrusion die 106 in that the uppermost body member 302A of the second exemplary annular co-extrusion die 106A is rotated by about 180 degrees, relative to the position of the uppermost body member 302 of the first exemplary annular co-extrusion die 106. As a result, as can be seen in FIGS. 3A and 5A, the respective feed channel inlets 346A, 348A of each body member 302A, 304A are offset from one another by about 180 degrees.

It is contemplated that in other embodiments, a feed channel may be formed in only one of the body members, with no feed channel being present in the passage-forming surface of the opposed body member.

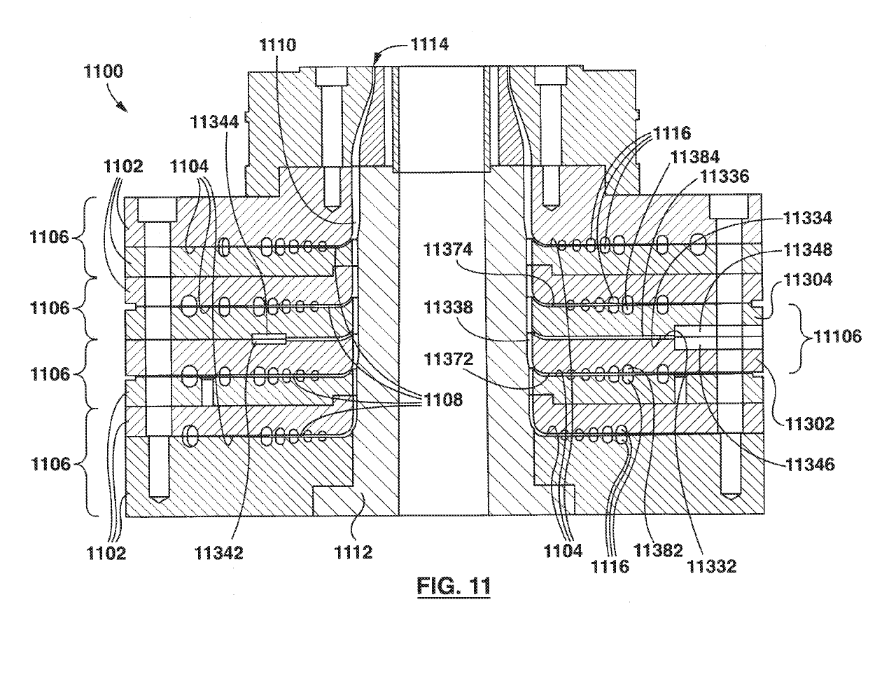

Annular co-extrusion dies according to the present disclosure can be integrated into co-extrusion structures incorporating conventional annular co-extrusion dies. Reference is now made to FIG. 11, which shows an exemplary co-extrusion structure 1100 comprising a plurality of annular co-extrusion dies, one of which is an annular co-extrusion die 11106 according to the present disclosure. The other annular co-extrusion dies 1106 are conventional. As can be seen in FIG. 11, the annular co-extrusion die 11106 according to the present disclosure is arranged in stacked relation adjacent other annular extrusion dies, in this case conventional annular co-extrusion dies 1106.

The conventional annular co-extrusion dies 1106 each comprise opposed body members 1102 having opposed, spaced-apart passage-forming surfaces 1104 that extend substantially perpendicularly to the extrusion direction E and cooperate to form a first portion 1108 of an annular passage. The first portion 1108 of the annular passage continues into, and in fluid communication with, a second portion formed by an annular gap between the body members 1102 (other than the lowermost body member 1102) and a central support member 1112; the second portions of the annular passage are in registration with one another and together form an annular extrusion passage 1110. The annular extrusion passage 1110 extends generally in the extrusion direction E, into an extrusion orifice 1114 in fluid communication therewith. Each body member 1102 has a respective spirally-extending open feed channel 1116 formed in its respective passage-forming surface 1104, with the depth of the feed channel 1116 progressively decreasing as the feed channel 1116 approaches the origin of the spiral. As is conventional, the feed channels 1116 are of curved cross-section such as semicircular, parabolic or otherwise substantially curved.

The annular co-extrusion die 11106 according to the present disclosure is similar to that described above, and comprises two body members 11302, 11304 arranged with their respective passage-forming surfaces 11332, 11334 opposed to and spaced from one another so that the gap between the passage-forming surfaces 11332, 11334 forms a first portion 11336 of an annular passage. The first portion 11336 of the annular passage extends substantially perpendicularly to the extrusion direction E into a second portion 11338 of the annular passage in fluid communication therewith. The second portion 11338 of the annular passage is formed by an annular gap between the uppermost body member 11344 and the central support member 1112; the second portion 11338 of the annular passage forms part of the annular extrusion passage 1110. Thus, the conventional annular co-extrusion dies 1106 each have a respective annular extrusion passage 1110 extending substantially in the extrusion direction E, and the second portion 11338 of the annular passage of each annular co-extrusion die 11106 is in registration with and in fluid communication with the annular extrusion passage 1110 of each conventional annular co-extrusion die 1106.

Each of the body members 11302, 11304 has a respective open feed channel 11342, 11344 formed in its respective passage-forming surface 11332, 11334. Each of the feed channels 11342, 11344 extends about 360 degrees in a spiral from a respective feed channel inlet 11346, 11348 as described above. The feed channels 11342, 11344 on the body members 11302, 11304 smoothly continuously decrease in depth, as measured from the respective passage-forming surfaces 11332, 11334, from the feed channel inlet 11346, 11348 to the end of the feed channel 11342, 11344. In other words, the feed channel 11342 continuously becomes shallower from the feed channel inlet 11346 to the end of the feed channel 11342, 11344. The feed channels 11342, 11344 are of substantially constant-width substantially rectangular cross-section along substantially their entire extent. The rectangular cross-section of the feed channels 11342, 11344 preferably has corners rounded to a radius of not more than about 1/16 of an inch, and more preferably the corners are rounded to a radius of not more than about 1/32 of an inch.

Optionally, as shown in FIG. 11, the body members 11302, 11304 of the annular co-extrusion die 11106 according to the present disclosure may be provided with respective second passage-forming surfaces 11372, 11374 opposite the respective first passage-forming surfaces 11332, 11334, and respective second open feed channels 11382, 11384 may be formed in the respective second passage-forming surfaces 11372, 11374. As can be seen in FIG. 11, the second open feed channels 11382, 11384 in the body members 11302, 11304 are of conventional curved cross-section and cooperate with the feed channel 1116 in an adjacent body member 1102 to form a conventional annular co-extrusion die 1106. Thus, each of the body members 11302, 11304 is part of the annular co-extrusion die 11106 according to the present disclosure and is also part of a conventional annular co-extrusion die 1106.

Other details of the co-extrusion structure 1100 shown in FIG. 11 are conventional and are not described further.

Although FIG. 11 shows a single annular co-extrusion die 11106 according to the present disclosure in stacked relation with a plurality of conventional annular co-extrusion dies 1106, in other embodiments a plurality of annular co-extrusion dies 11106 according to the present disclosure may be arranged in stacked relation with one or more conventional annular co-extrusion dies 1106.

Although a generally flat, non-nested die arrangement has been illustrated and described for ease of explanation, one skilled in the art, now informed by the present disclosure, will appreciate that feed channels of substantially constant-width substantially rectangular cross-section may be incorporated into other types of co-extrusion die arrangements, including, for example, nested frusto-conical co-extrusion die arrangements such as those taught by U.S. Pat. No. 7,097,441 to Sagar et al., the teachings of which are hereby incorporated by reference in their entirety. In such embodiments, the feed channels will be arranged with their sides substantially perpendicular to the flow surface.

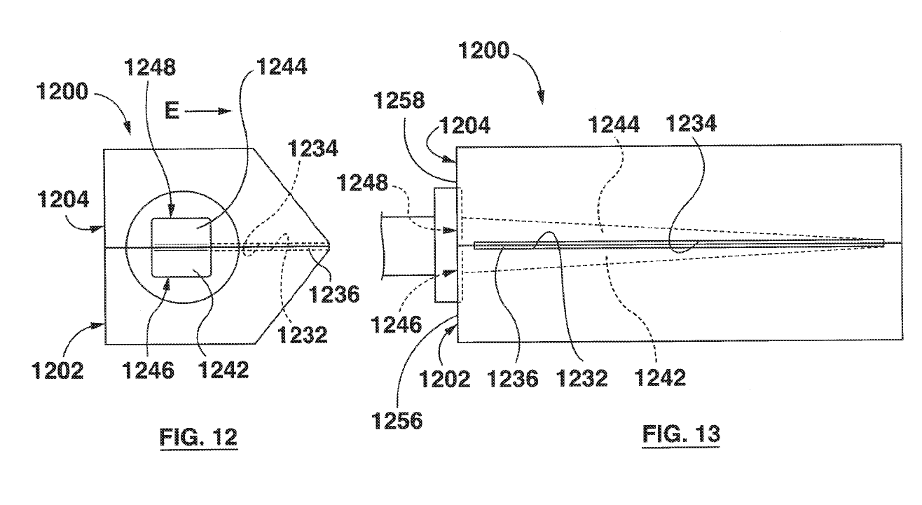

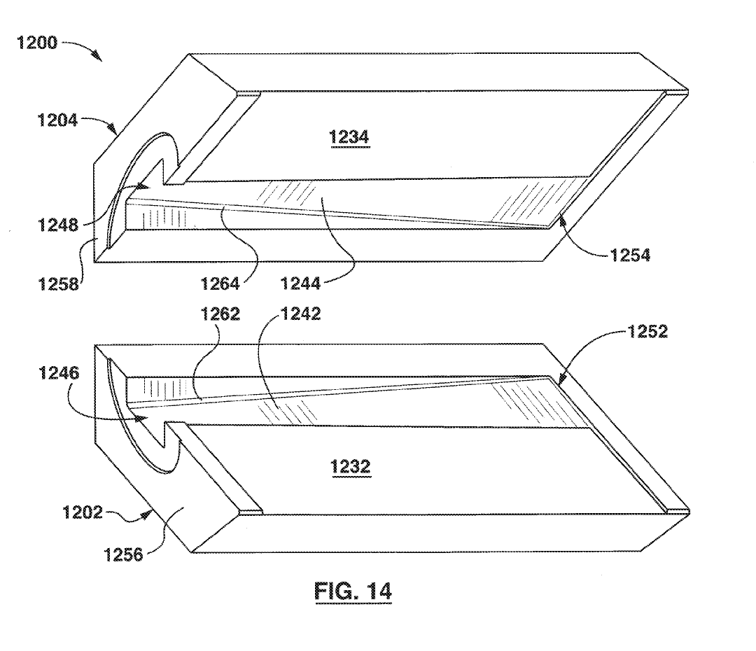

Feed channels of substantially constant-width substantially rectangular cross-section may also be used in cast film applications. Reference is now made to FIGS. 12 to 14, which show a co-extrusion die 1200 for extruding cast film. The co-extrusion die 1200 comprises two body members 1202, 1204. As best seen in FIG. 14, the body members 1202, 1204 each have a respective passage-forming surface 1232, 1234. As can be seen in FIG. 12, the passage-forming surfaces 1232, 1234 each extend substantially parallel to the extrusion direction E. The body members 1202, 1204 are arranged with their respective passage-forming surfaces 1232, 1234 opposed to and spaced from one another so that the gap between the passage-forming surfaces 1232, 1234 forms an extrusion passage 1236.

Each of the body members 1202, 1204 has a respective open feed channel 1242, 1244 formed in its respective passage-forming surface 1232, 1234. Each of the feed channels 1242, 1244 extends substantially linearly from a respective feed channel inlet 1246, 1248 disposed at the outer edge 1256, 1258 of the respective body member 1202, 1204. As best seen in FIG. 14, in the illustrated embodiment the feed channels 1242, 1244 extend in the same (i.e. common) direction from the respective feed channel inlet 1246, 1248; i.e. the feed channel inlets 1246, 1248 cooperate to form a common inlet; in other embodiments the feed channels 1242, 1244 may extend in opposite directions. As best seen in FIG. 12, in the illustrated embodiment the feed channels 1242, 1244 overlap one another.

As can be seen in FIG. 14, the feed channels 1242, 1244 on the body members 1202, 1204 smoothly continuously decrease in depth, measured from the respective passage-forming surface 1232, 1234, from the respective feed channel inlet 1246, 1248 to the end 1252, 1254 of the respective feed channel 1242, 1244. Thus, the feed channels 1242, 1244 continuously become shallower from the respective feed channel inlet 1246, 1248 to the end 1352, 1354 of the respective feed channel 1242, 1244. It can also be seen in FIG. 14 that the feed channels 1242, 1244 are of substantially constant-width substantially rectangular cross-section along substantially their entire extent. The rectangular cross-section of the feed channels 1242, 1244 preferably has corners 1262, 1264 rounded to a radius of not more than about 1/16 of an inch, preferably not more than about 1/32 of an inch. The feed channels 1242, 1244 are arranged with their sides substantially perpendicular to the respective flow surface formed by the respective passage-forming surface 1232, 1234.

Certain currently preferred embodiments have been described by way of example. It will be apparent to persons skilled in the art that a number of variations and modifications can be made without departing from the scope of the claims.

1. A body member for an extrusion die for multilayer film, wherein:
the body member has a passage-forming surface;
the body member has at least one open feed channel formed in the passage-forming surface;
each feed channel continuously decreases in depth from the feed channel inlet thereof;
wherein each feed channel is of substantially constant-width substantially rectangular cross-section along substantially an entire extent of the respective feed channel.

2. The body member of claim 1, wherein the rectangular cross-section of the feed channel has comers rounded to a radius of not more than about 1/16 of an inch.

3. The body member of claim 2, wherein the comers are rounded to a radius of not more than about 1/32 of an inch.

4. The body member of claim 1, wherein the body member is a body member for an annular co-extrusion die for blown film, and wherein:
the feed channel extends in a spiral from the feed channel inlet;
the feed channel extends, from the feed channel inlet, at least 180 degrees around an origin of the spiral.

5. The body member of claim 4, wherein the feed channel extends, from the feed channel inlet, at least 360 degrees around the origin of the spiral.

6. The body member of claim 5, wherein the feed channel extends, from the feed channel inlet, between 360 degrees and 720 degrees around the origin of the spiral.

7. The body member of claim 4, wherein the body member is annular.

8. An annular co-extrusion die for blown plastic film, comprising:
two body members as claimed in claim 4;
the body members arranged with their respective passage-forming surfaces opposed to one another to form a first portion of an annular passage therebetween;
the first portion of the annular passage being substantially perpendicular to the extrusion direction;
a second portion of the annular passage extending generally in the extrusion direction and extending into an annular extrusion orifice in fluid communication therewith;
the first and second portions of the annular passage being continuous with one another and in fluid communication with one another.

9. The annular co-extrusion die of claim 8, wherein the respective spirals formed by the feed channels extend in opposite directions.

10. The annular co-extrusion die of claim 9, wherein the respective spirals formed by the feed channels overlap one another.

11. The annular co-extrusion die of claim 8, further comprising an annular membrane arranged in parallel with the passage-forming surfaces to bisect the annular passage.

12. The annular co-extrusion die of claim 8, further comprising:
a feed block adaptor having a longitudinally extending bore of substantially rectangular cross-section;
wherein the respective feed channel inlets cooperate to form a common feed channel inlet of substantially rectangular cross-section corresponding in size and shape to the bore of the feed block adaptor; and
wherein the bore of the feed block adaptor is in registration with the common feed channel inlet.

13. A co-extrusion structure comprising:
at least one annular co-extrusion die as claimed in claim 8 arranged in stacked relation adjacent at least one other annular extrusion die;
each other annular extrusion die having a respective annular extrusion passage extending substantially in the extrusion direction;
wherein the second portion of the annular passage of each annular co-extrusion die as claimed in claim 8 is in registration with and in fluid communication with the annular extrusion passage of each other annular extrusion die.

14. The annular co-extrusion die as claimed in claim 8, wherein the feed channel inlets of each body member are in registration with one another.

15. The annular co-extrusion die as claimed in claim 8, where the feed channel inlets of each body member are offset from one another.

16. The annular co-extrusion die as claimed in claim 15, where the feed channel inlets of each body member are offset from one another by about 180 degrees.

17. The body member of claim 1, wherein the body member is a body member for a co-extrusion die for extruding cast film, and wherein the feed channel extends substantially linearly from the feed channel inlet.

18. A co-extrusion die for extruding cast film, the co-extrusion die comprising:
two body members as claimed in claim 17;
the body members arranged with their respective passage-forming surfaces opposed to one another to form an extrusion passage therebetween.

19. The co-extrusion die of claim 18, wherein the feed channels extend in a common direction from a common inlet.

20. The co-extrusion die of claim 19, wherein the feed channels overlap one another.
